(19) United States
(12) Patent Application Publication
(10) Pub. No.: US 2026/0197032 A1
(43) Pub. Date: Jul. 9, 2026

(54) SYSTEMS, METHODS AND COMMUNICATIONS DEVICES

(71) Applicant: Sony Group Corporation, Tokyo (JP)

(72) Inventors: Martin Warwick BEALE, Basingstoke (GB); Shin Horng WONG, Basingstoke (GB); Samuel Asangbeng ATUNGSIRI, Basingstoke (GB)

(73) Assignee: Sony Group Corporation, Tokyo (JP)

(21) Appl. No.: 19/132,893

(22) PCT Filed: Dec. 4, 2023
(86) PCT No.: PCT/EP2023/084172

§ 371 Date: May 27, 2025

(30) Foreign Application Priority Data
Dec. 5, 2022 (EP) 22211530.5

(51) Int. Cl. H04B 5/77

(52) U.S. Cl. CPC H04B 5/77

(57) ABSTRACT

System, methods, communications devices and devices are disclosed herein for utilisation of backscattered signal communication by devices operating in cellular networks. In particular, the duration of a carrier wave signal used for backscattering can be changed dynamically and/or the carrier wave signal can be interrupted and re-commenced/re-transmitted. As such, the transmission duration of the carrier wave signal can be tailored to the number of tags in the system. A command signal in the communication process may signal the timing of the carrier wave signal, the carrier wave signal may be terminated early, and/or the communications device (reader) may estimate the number of tags before determining the duration of the carrier wave signal.

The present application claims the Paris Convention priority of European patent application EP22211530.5, filed 5 Dec. 2022, the contents of which are hereby incorporated by reference.

### BACKGROUND

### Field of Disclosure

The present disclosure relates to a communications device, a device and methods of operating a communications device configured to receive data from a wireless communications network.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Modern mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Wireless communications networks are expected to routinely and efficiently support communications with an ever-increasing range of devices associated with a wide range of data traffic profiles and types. For example, it is expected that wireless communications networks efficiently support communications with devices including reduced complexity devices, machine type communication (MTC) devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is a desire for current generation wireless communications networks, for example those referred to as 5G or new radio (NR) systems/new radio access technology (RAT) systems, as well as future iterations/releases of existing systems, to efficiently support connectivity for a wide range of devices associated with different applications and different characteristic data traffic profiles and requirements.

5G NR has continuously evolved and the current work plan includes 5G-NR-advanced in which some further enhancements are expected, especially to support new use-cases/scenarios with higher requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

According to a first aspect, there is provided a method for a communications device configured to transmit and/or receive signals within a wireless communications network via a wireless radio interface provided by the wireless communications network. The method comprises: transmitting, for detection by one or more other devices, a command signal, wherein the command signal requests a response from the one or more other devices; transmitting, for detection by the one or more other devices, a carrier wave (CW) signal, wherein the CW signal has timing parameters which are changeable properties of the CW signal determined by the communications device according to one or more factors; receiving, from the one or more other devices, one or more backscattered signals in response to the CW signal, wherein the one or more backscattered signals indicate a response to the command signal for the one or more other devices.

According to a second aspect, there is provided a method for a device configured to transmit a backscattered signal in response to a carrier wave (CW) signal from a communications device. The method comprises: receiving, from a communications device, a command signal, wherein the command signal requests a response from the device; receiving, from the communications device, the CW signal, wherein the CW signal has timing parameters which are changeable properties of the CW signal determined by the communications device according to one or more factors; and transmitting, to the communications device, a backscattered signal in response to the CW signal, wherein the backscattered signal indicates a response to the command signal for the device.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIGS. 4A-D illustrate backscattering communication by a tag in response to an incident signal from a reader.

FIG. 5 illustrates the communication process between an RFID reader and an RFID tag for obtaining an identifier from the RFID tag.

FIG. 6 illustrates an example process for a communications device to obtain an identifier for a device using backscattering techniques according to an example teaching of the present disclosure.

FIG. 7 illustrates an example process for a communications device to obtain an identifier for a device using backscattering techniques according to an example teaching of the present disclosure.

FIG. 8 illustrates an example process for a communications device to obtain an identifier for a device using backscattering techniques according to an example teaching of the present disclosure.

FIG. 9 illustrates an example process for a communications device to obtain an identifier for a device using backscattering techniques according to an example teaching of the present disclosure.

FIG. 10 illustrates an example process for a communications device to obtain an identifier for a device using backscattering techniques according to an example teaching of the present disclosure.

FIG. 11 illustrates an example process for a communications device to obtain an identifier for a device using backscattering techniques according to an example teaching of the present disclosure.

FIG. 12 illustrates an example process for a communications device to obtain an identifier for a device using backscattering techniques according to an example teaching of the present disclosure.

FIG. 13 illustrates an example method for a communications device according to an example of the present disclosure.

FIG. 14 illustrates an example method for a device configured to transmit a backscattered signal in response to a carrier wave signal according to an example of the present disclosure.

### DETAILED DESCRIPTION OF THE EMBODIMENTS

### Long Term Evolution Advanced Radio Access Technology (4G)

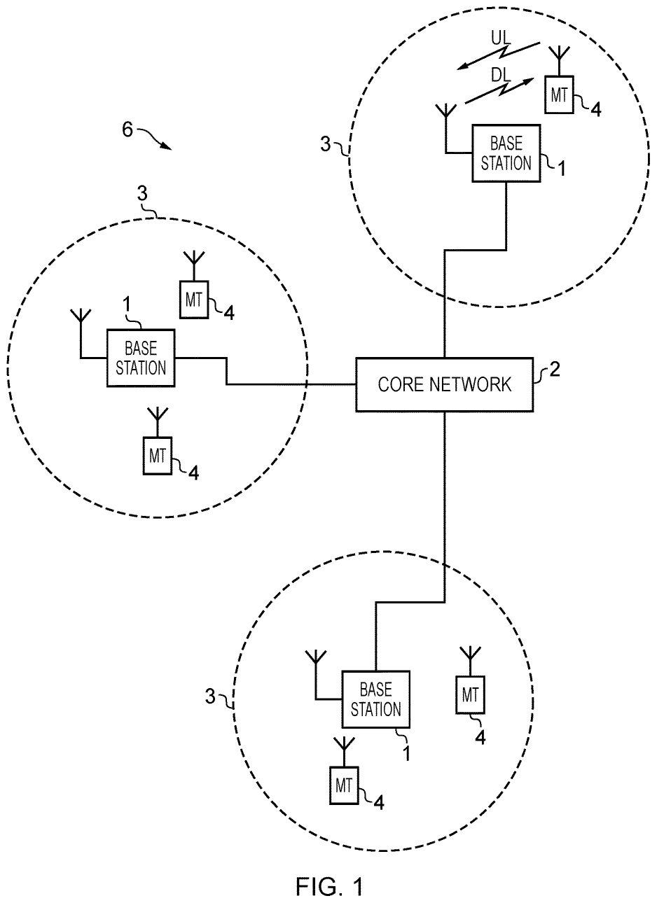

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices or mobile terminals (MT) 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. The communications or terminal devices 4 may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G (NR))

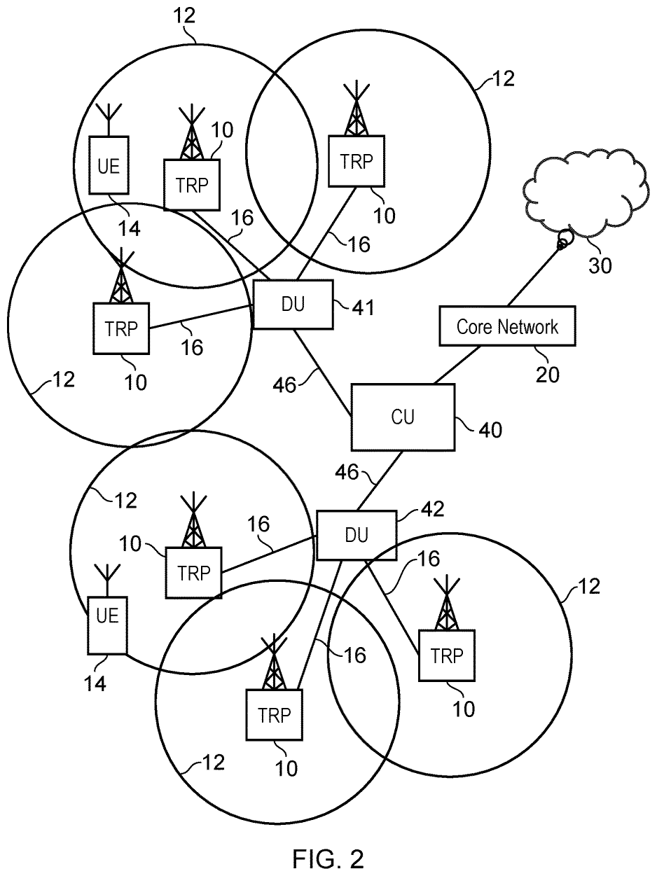

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

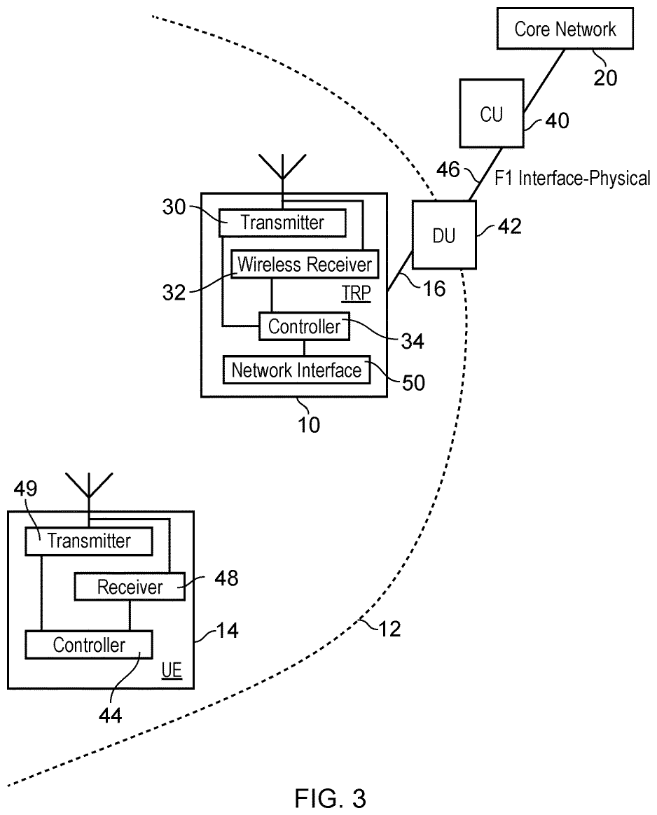

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter circuit 49, a receiver circuit 48 and a controller circuit 44 which is configured to control the transmitter circuit 49 and the receiver circuit 48 to transmit signals representing uplink data to the wireless communications network via the wireless access interface formed by the TRP 10 and to receive downlink data as signals transmitted by the transmitter circuit 30 and received by the receiver circuit 48 in accordance with the conventional operation.

The transmitter circuits 30, 49 and the receiver circuits 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controller circuits 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473, and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP10 to the DU 42 and the F1 interface 46 from the DU 42 to the CU 40.

### Passive-Internet of Things (IoT)

The Internet of Things (IoT) is an area of current focus in the field of wireless communications. IoT technologies allow ever-increasing numbers of devices to be connected to one another and to the Internet, providing greater comforts and efficiency. It is expected that the total number of IoT devices may rise to tens of billions or even hundreds of billions of devices for various applications, facilitated primarily by increasing reductions in size, complexity and power consumption for IoT devices. Many use cases make the use of IoT devices that rely on batteries that periodically require recharging or replacing impractical or impossible, and, with the increasing number of IoT devices, doing so would be expensive and also present environmental and safety concerns.

At present, most existing wireless communications devices are powered by a battery that requires periodic recharging or replacing. However, the automation and digitalization of various industries may generate interest in new IoT technologies supporting battery-less devices having no energy storage capability, or devices with minimal energy storage (such as a single capacitor) that do not need periodic charging or replacement. Such devices are expected to be small in size. In such cases, it is expected that power would be provided to such IoT devices through the harvesting of radio waves, light, motion, heat, or any other power source that could be seen as suitable. The output power of energy harvesting technologies is typically from 1 μW to a few hundreds of μW, and as such existing cellular devices are unsuitable for powering with energy harvesting technologies, due to their peak power consumption of above 10 mW.

One possible application of such battery-less IoT devices is asset identification. Thus far, asset identification has required the use of barcode or RFID technology in most cases. One main advantage of these two technologies is the ultra-low complexity and small form factor of the RFID tags. However, the limited reading range of a few metres from which these tags can be read usually requires either handheld scanning, leading to labor-intensive and time-consuming operations, or RFID portals/gates, which leads to costly deployments. Moreover, these technologies do not employ interference management schemes, which can result in severe interference between multiple RFID tags, and therefore limit capacity, especially in cases of dense deployment.

Since existing technologies cannot meet all the requirements of target use cases, new IoT technologies are required to open new markets within 3GPP systems, whose number of connections and/or device density can be orders of magnitude higher than existing 3GPP IoT technologies. Such new IoT technologies may have levels of complexity and power consumption that is orders of magnitude lower than the existing 3GPP low-power wide-area (LPWA) technologies (e.g. narrow band (NB)-IoT and enhanced machine type communication (eMTC)), and may address use cases and scenarios that cannot otherwise be fulfilled based on existing 3GPP LPWA IoT technologies.

RFID is an example of a passive-IoT system. In RFID use cases, incident EM (electromagnetic) energy generated by an RFID reader is harvested by an RFID tag which may, in some cases, be stored within the tag (e.g. in a capacitor). An RFID tag is able to receive a downlink message from a reader using a low power receiver. Depending on the sophistication of the RFID system, the downlink message can consist of a bit string that is parsed by the tag. The harvested energy is sufficient to power the circuitry that demodulates the bit sequence. A passive RFID tag responds to the downlink message by reflecting a signal from the reader, where the reflected waveform is modulated with a signal. The reflected waveform is typically on-off keying (OOK) or frequency-shift keying (FSK) modulated. This method of passively communicating is termed backscattering communication.

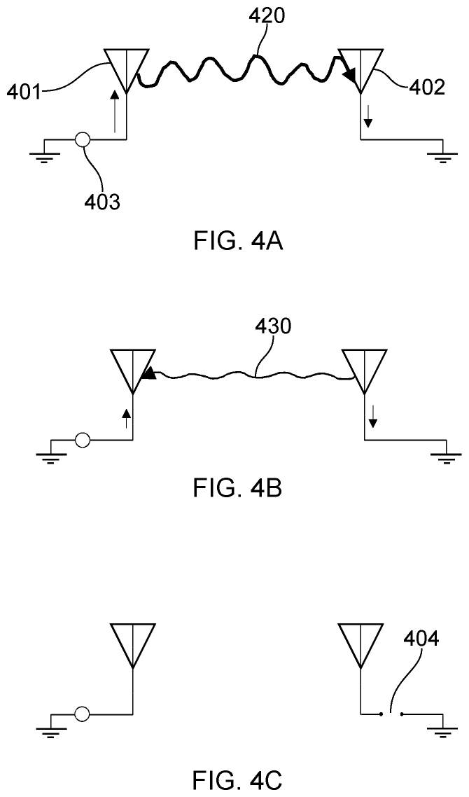

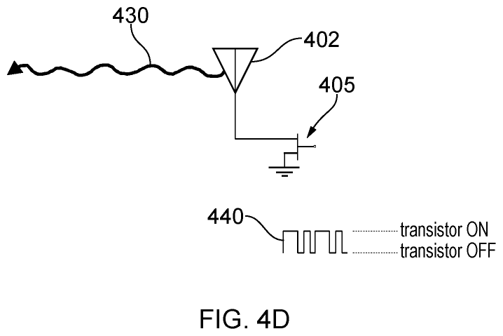

FIGS. 4A-D illustrate a simplified diagram demonstrating backscattering communication, as utilised in existing RFID technologies [2]. The antenna shown on the left of FIG. 4A is for an RFID reader 401, while the antenna shown on the right of FIG. 4A is for an RFID tag 402. Both the reader 401 and tag 402 are shown as including an antenna connected to ground, while the reader 401 includes a power source 403. The power source 403 generates a current in the reader 401 circuitry, which causes the antenna of the reader 401 to transmit an RF signal 420 towards the tag 402, as shown in FIG. 4A. The RF signal 420 is incident on (i.e. lands on) the receive antenna of the tag 402. The incident RF signal 420 causes the creation of a current in the tag 402 circuitry, for example when the receive antenna is short-circuited (as shown in FIG. 4B). In contrast, if the tag 402 antenna circuitry is open 404 (as shown in FIG. 4C) no current is generated in the tag 402 antenna circuitry.

The current in the tag 402 circuitry generates an electromagnetic wave (EM) 430 that is emitted by the tag 402 antenna and that can be detected by the reader antenna 401. In contrast, if, as in FIG. 4C, the tag 402 antenna circuitry is open 404, no current is generated in the tag 402 antenna circuitry and thus no EM wave 430 is emitted. Accordingly, it is possible to modulate the electromagnetic wave 430 by short-circuiting and open-circuiting the tag 402 antenna, for example using a transistor 405, as shown in FIG. 4D. That is, the EM wave 430 may be turned on or off via the transistor 405 to generate a modulated signal 440. Moreover, this may be achieved using only power harvested from the RF signal 420 transmitted by the reader 401. This modulation technique may be used to embed information into the EM wave 430, such as an ID for the tag 402.

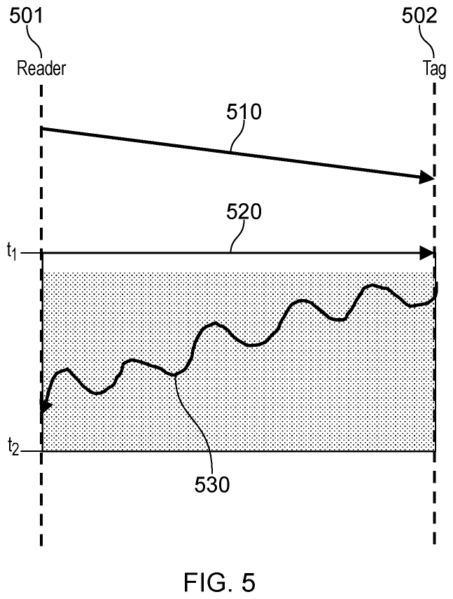

In RFID systems, each tag (such as tag 402) has an identifier (ID), which may or may not be a unique ID. When the tag detects a signal from a reader (such as reader 401) requesting a tag ID, the tag responds with its ID, e.g. using the backscattering techniques described in relation to FIGS. 4A-D. FIG. 5 illustrates this RFID signaling procedure. An RFID reader 501 transmits a command signal 510 to an RFID tag 502. The command signal 510 may, for example, request/instruct/indicate the tag 502 to respond with its ID. The command signal 510 may also include other information such as a data rate or chip rate to be used by the tag for the backscattering signal. Such commands may be sent in the command signal 510 in a number of ways, such as by modulating the width of a pulse (pulse width modulation), or modulating the position of a pulse (pulse position modulation), however other techniques are possible. Furthermore, the number of bits that can be carried by the command signal is in general not limited, but when a simple modulation scheme is used, the number of bits that can be transmitted is limited.

The reader 501 then sends a continuous wave/carrier wave (hereinafter referred to as “carrier wave”) (CW) signal 520 (shown as a rectangular box with an arrow in FIG. 5) to the tag 502. The CW signal 520 is transmitted over a length time (from time t₁ to time t₂ in FIG. 5) and may include a continuous signal transmitted for a defined duration or a plurality of signals transmitted within the duration of the CW signal 520. The tag 502 reflects the CW signal 520 (e.g. using the backscattering techniques described above) to emit a backscattered signal 530 that may be received by the reader 501. The backscattered signal may contain a response to the command signal 510 that was initially sent by the reader 501 (e.g. the backscattered signal 530 may indicate the identifier for the tag 502). In some examples, there may be a gap between the end of the command signal 510 and the beginning of the CW signal, however in some implementations there may be no gap between the end of the command signal 510 and the beginning of the CW signal, such that the command signal is transmitted as a first (initial) part/portion of the CW signal. This is particularly beneficial for tags that have no energy storage at all, as the tag can be powered continuously by incident EM energy from the reader for the duration of the RFID retrieval process.

New passive-IoT technologies, such as those discussed above, for cellular network devices may utilise similar processes to those described above in relation to FIGS. 4A-D and FIG. 5, in order to allow operation with battery-less devices or devices with limited energy storage. An example use case of a system such as that of FIG. 5 is to track or locate packages in a warehouse. In such a scenario, there may be many tags within communication range of the reader. This may create a collision problem at the reader. Specifically, a large number of tags may send backscattered signals to the reader at the same time. The multiple backscattered signals may interfere with each other and hence be undecodable at the reader. Accordingly, the reader may not be able to determine the IDs of the tags. One known method of separating the signals from multiple tags is for the tags to respond to the reader at different times. If the different tags choose random times at which to send their signals, the probability of the signals from two different tags colliding is reduced.

One drawback of such an approach is that the reader needs to transmit the CW signal for a long period of time i.e. long enough for the different tags to choose different random times at which to send a backscattered signals. Sending the CW signal for a long period of time has a number of drawbacks, such as greater energy consumption at the reader; increased latency, as tags that choose a later random time to transmit the backscattered signal will be detected at the reader with a significant delay; inefficient use of spectral resources, as when the reader sends the CW signal the spectrum and power used by that CW signal cannot be used for other communication purposes; and interference caused by the CW signal at other readers/devices.

Conversely, as discussed above, transmitting the CW signal for a short period of time also has a number of drawbacks, such as an increased number of collisions/increased interference between backscattered signals when multiple tags try to transmit at the same time, as well as limited capacity.

These drawbacks make the above-discussed backscattering techniques particularly unsuited to devices operating in cellular systems (such as a terminal device/UE, or transceiver stations, nodeBs, e-nodeBs, eNB, g-nodeBs, or gNB (hereinafter referred to as a gNB for brevity)). However, the present inventors have identified a new approach for utilising backscattering techniques suitable for use by devices such as a UE or gNB operating in a wireless communications network that addresses the aforementioned problems.

According to examples of the present disclosure, the timing parameters of a carrier wave (CW) signal can be set or adjusted by the reader according to a number of factors. That is, the timing parameters are changeable properties of the CW signal determined by the communications device according to one or more factors. As such, a reader may transmit different CW signals (at different times) having different timing parameters, based on various factors. For example, the duration of the CW signal can be changed dynamically, for example based on the number of tags in the system. Additionally or alternatively, the CW signal may be interrupted and re-commenced, allowing for multiplexing of the CW signal with other transmissions (e.g. legacy wireless transmissions such as those discussed above in relation to FIGS. 1-3).

According to an example teaching of the present disclosure, the command signal may indicate timing parameters of the CW signal to the tag. The tag may then determine a random time to transmit the backscattered signal between the start of the CW signal and the end of the CW signal. The following examples are discussed in terms of a reader and tag, however the reader may be a UE or gNB such as those described in relation to FIGS. 1-3, and the tag may be another device which may or may not be capable of communicating via a wireless radio interface provided by a wireless communications network, and as such may be generally referred to as a device, communications device, or backscattering communications device.

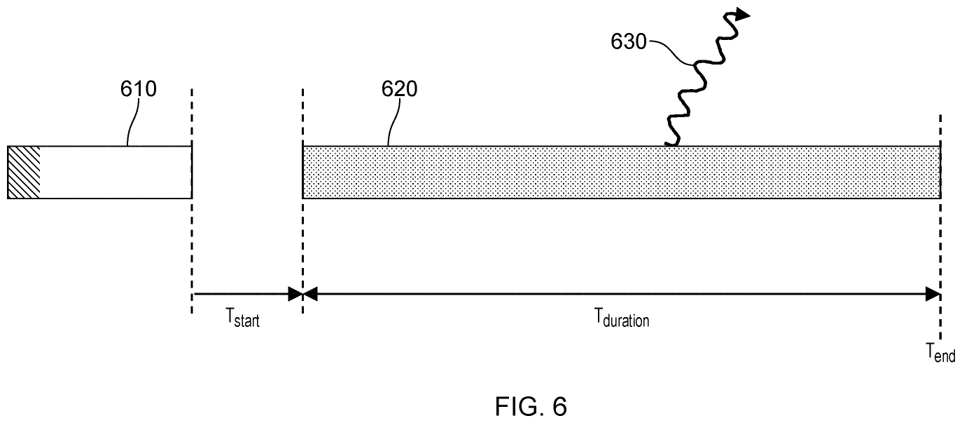

FIG. 6 illustrates an example teaching according to the present disclosure. In the example teaching of FIG. 6, one or more timing parameters of the CW signal may be indicated by the command signal. For example, the start time and end time of the CW signal may be indicated by the command signal. That is, since there may be a gap between the command signal and CW signal, the command signal can indicate the start time of the CW signal relative to a known point within the command signal. Alternatively, the start time and duration of the CW signal can be indicated in the command signal.

As shown in FIG. 6, the command signal 610 is initially transmitted to the tag by the reader. The reader commences transmission of the CW signal 620 at the start time, Tₛₜₐᵣₜ, and continues to transmit the CW signal 620 for a duration, T_{duration}, of the CW signal 620 until the end time, T_{end}, where T_{end}=Tₛₜₐᵣₜ+T_{duration}. In this example, the command signal 610 may indicate Tₛₜₐᵣₜ and T_{end} to the tag. That is, these times may be indicated to the tag relative to a given time in the command signal (e.g. the beginning or end of the command signal 610). Accordingly, the tag chooses a random time between time Tₛₜₐᵣₜ and time T_{end} in which to transmit the backscattered signal 630. Accordingly, the reader is able to adjust the length and timing of the CW 620 signal to account for various different factors, such as signal multiplexing or a large number of tags, whilst ensuring that the tag transmits the backscattered signal 630 at an appropriate time. That is, rather than the duration of the CW signal 620 being fixed and/or the tag transmitting the backscattered signal within a defined time period that may be less than the duration of the CW signal 620, the length of the CW signal 620 and therefore the time period in which the tag may transmit the backscattered signal 630 may be optimised on a case-by-case basis.

In some examples, the command signal 610 may not indicate the start time, Tₛₜₐᵣₜ, of the CW signal 620 and instead only indicate the end time, T_{end}, of the CW signal 620 (e.g. relative to a given time in the command signal). In other examples, the command signal 610 may not indicate T_{end} or Tₛₜₐᵣₜ, but may instead indicate T_{duration}. This is particularly useful in examples where the gap between the command signal 610 and the CW signal 620 is small or does not exist, as the tag may choose a time to transmit the backscattered signal 630 within T_{duration} of the time at which it first detects the CW signal. In other examples, the command signal 610 may also indicate a delay, Tdelay, where the CW signal 620 of duration T_{duration} starts after the end of the command signal 610 (alternatively the reference point for Tdelay may be the start of the command signal 610).

According to another example teaching of the disclosure, a CW signal may be terminated before the expected end time, where the end time may or may not have been signalled in the command signal. This provides scheduling flexibility to the reader (which may e.g. be a UE or gNB such as those described in relation to FIGS. 1-3), allowing the CW signal to be stopped to allow a higher priority signal to be sent instead. The tag can determine the presence/absence of the CW signal, for example via an energy detection circuit.

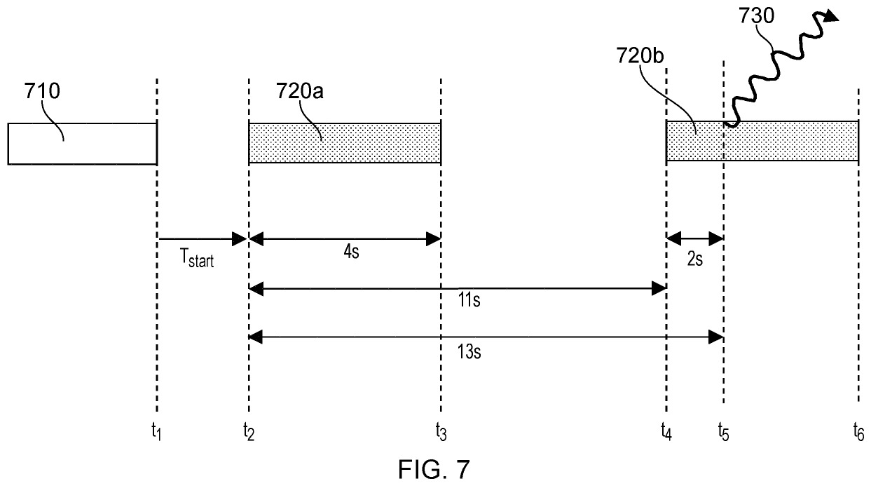

FIG. 7 shows an arrangement according to this example teaching. In this example, the reader determines that it will send a CW signal 720 for ten seconds and the tag determines that it will transmit the backscattered signal 730 after six seconds. The reader transmits a first command signal 710 for receipt by the tag, where the command signal may optionally provide the tag with timing parameters for the CW signal 720. The transmission of the command signal 710 by the reader finishes at time t₁, and the transmission of the CW signal 720 (specifically a first portion 720a of the CW signal 720) by the reader begins at time t₂, which is a length of time Tₛₜₐᵣₜ after t₁. At time t₃, which in the present example is four seconds after t₂ (i.e. the CW signal 720a was transmitted for four seconds rather than the intended ten seconds), the reader terminates transmission of the CW signal 720a. Then at time t₄, the reader re-commences transmission of the CW signal 720 (i.e. begins transmission of a second portion 720b of the CW signal 720). At time t₅, which is two seconds after time t₄, the tag transmits the backscattered signal 730 for receipt by the reader. At time to, the reader ends transmission of the second portion 720b of the CW signal 720.

In this example, as the CW signal 720 is interrupted, the tag may monitor the cumulative time in which the CW signal 720 is transmitted in determining when to transmit the backscattered signal. That is, the tag may consider the second portion 720b to be a continuation/extension of the first portion 720a of the CW signal 720. As such, a second command signal may not be required in order to allow for an interruption in the CW signal 720.

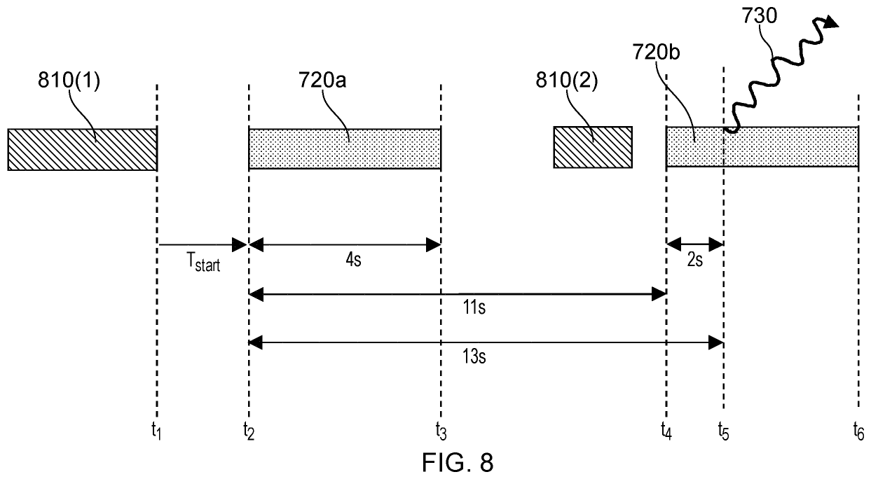

Conversely, in some examples as shown in FIG. 8, a first command signal 810(1) may be sent in a similar manner to command signal 710, in addition to a second command signal 810(2) transmitted between the first portion 720a and the second portion 720b of the CW signal 720. The second command signal 810(2) may explicitly indicate to the tag that the second portion 720b of the CW signal 720 is a continuation of the first portion 720a of the CW signal 720. Alternatively, the second command signal 810(2) may indicate that the second portion 720b is a new CW signal and the tag may therefore determine that it should restart its count. In other words, in some examples in the absence of a second command signal 810(2) explicitly indicating that the second portion 720b is a continuation of the first portion 720a, the tag may consider the second potion 720b to belong to a new CW signal and may therefore restart its count. In other words, in such an example the tag would restart counting at time t₄ and transmit the backscattered signal 730 six seconds after time t₄ (provided the CW signal length is at least that long).

In some examples, the second command signal 810(2) may indicate to the tag that the CW signal will stop. For example, the reader may begin transmitting the second command signal 810(2) at or shortly after time t₃ to inform the tag that the CW signal 720 is interrupted, and the second command signal 810(2) may also indicate that the CW signal 720 will recommence. The CW signal 720 (as in FIGS. 7 and 8) may be interrupted for a number of reasons, for example because the reader (which may be a UE or a gNB) may need to transmit or receive/read a transmission within the wireless communications network. For example, 3GPP networks may include known repeating signal features, such as a synchronization signal blocks (SSB) or system information blocks (SIB), or other repeating signals that are scheduled via a configured grant. The reader may therefore be unable to transmit a CW signal at the time of these repeating signals. Accordingly, the CW signal may only be available for the tag to transmit the backscattered signal at particular times.

In some examples, the reader may indicate these availability times to the tag in the command signal. For example, the tag may then determine a transmission time for the backscattered signal based on a real time since the start of the CW signal. For example, revisiting FIG. 7, the command signal 710 may indicate to the tag when the CW signal 720 will be available. The tag may then determine a time to transmit the backscattered signal based on a total time since the start of the CW signal (i.e. a real time), which may cover multiple portions of the CW signal. For example, the tag may decide to transmit the backscattered signal six seconds after the start of the CW signal 720 transmission, ignoring any gaps between portions of the CW signal. Alternatively, the tag may determine the time to transmit the backscattered signal based on a cumulative time for which the CW signal 720 has been transmitted. For example, the tag may decide to transmit the backscattered signal when the CW signal 720 has been transmitted for a total of six seconds (potentially across multiple discrete portions 720a, 720b).

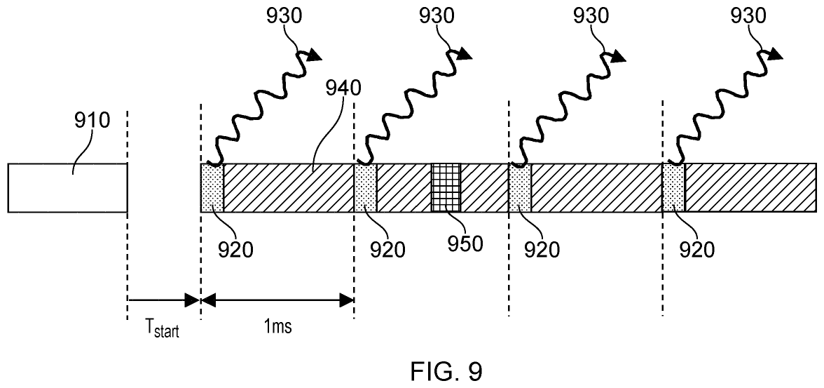

In some examples, the times at which the CW signal will be available may be known in advance. In other words, the CW signal may include known gaps i.e. non-zero times between discrete portions of the same CW signal where the CW signal is not transmitted. As an example, the reader may only transmit the CW signal in the first two orthogonal frequency-division multiplexing (OFDM) symbols of each slot for a given number of slots or a given time duration. An example of this is shown in FIG. 9. In FIG. 9, a command signal 910 is sent by a reader requesting that a tag (or a number of tags) provides its ID by backscattering 930 a CW signal 920.

The system shown in FIG. 9 includes a number of slots, each 1 ms long, starting at time Tₛₜₐᵣₜ. These slots may be the slots of an NR frame structure or the subframes of an LTE frame structure. The CW signal 920 is transmitted only at the beginning of each slot, e.g. in the first two OFDM symbols of the slot. Accordingly, the reader may multiplex other legacy signals 940, such as a physical downlink control channel (PDCCH), physical downlink shared channel (PDSCH), or SSB 950 with the CW signal 920 such that the legacy signals 940 are transmitted in the gaps between the CW signals 920. In the present example, the CW signal 920 duration may be specified as being 4 ms, as the CW signal 920 is spread across four slots each of 1 ms.

The command signal 910 may in some examples indicate the timing parameters for the CW signal 920 (e.g., the times at which the CW signal 920 will be transmitted, and/or a total duration of the CW signal 920). Accordingly, the tag may only attempt to transmit a backscattered signal 930 during the transmission of the CW signal 920. Alternatively, the command signal 910 may not indicate the timing parameters of the CW signal 920 and the tag may perform backscattering 930 only when the CW signal 920 is detected.

According to an example teaching of the disclosure, a reader may estimate the number of tags that are likely to detect a CW signal and therefore transmit a backscattering signal, and the reader may use this estimate of the number of tags in determining timing parameters for the CW signal. For example, if it is estimated that a large number of tags will receive the CW signal, the reader may determine that there is a high chance of interference between backscattered signals which the tags transmit at random times. Accordingly, the reader may transmit the CW signal for a longer duration to allow the tags to transmit the backscattered signals within a larger time window, thereby reducing the chances of interference between backscattered signals.

In some examples, the reader may estimate the number of tags based on a previous cycle of reading tag IDs in a particular location. For example, if the reader reads tags in the north of a warehouse facility housing an office complex, a small number of tags may be expected, whereas if the reader reads tags in the south of the warehouse facility where crates of product are stored, a large number of tags may be expected. As such, the reader may use location data from the reader device (e.g. the UE or the gNB) when estimating the number of tags.

Therefore, in some examples, in future cycles of tag reading if the reader sends a beam with a CW signal in a northerly direction to read tags, a short duration CW signal may be used, whereas a longer CW signal may be used when the reader sends a CW signal in a southerly direction.

In addition to or as an alternative to using historical and/or location data to estimate the number of tags, the reader may perform an initial measurement of the number of tags before requesting IDs from the tags. That is, the reader may transmit a first command signal which requests that tags transmit an indication of their existence (i.e. an indication that the tag received the command signal) to the reader. The reader may then transmit a short CW signal for the tags to indicate whether they received the first command signal. The tags may then transmit a backscattered signal indicating that they received the first command signal. This backscattered signal may in some cases be one bit (i.e. an existence bit), which reduces power requirements for the reader and reduces the duration of the CW signal. The reader may then count the number of backscattered signals (i.e. count the number of existence bits) received in order to estimate the number of tags. Based on the estimated number of tags, the reader may then determine timing parameters for the CW signal, such as the duration of the CW signal.

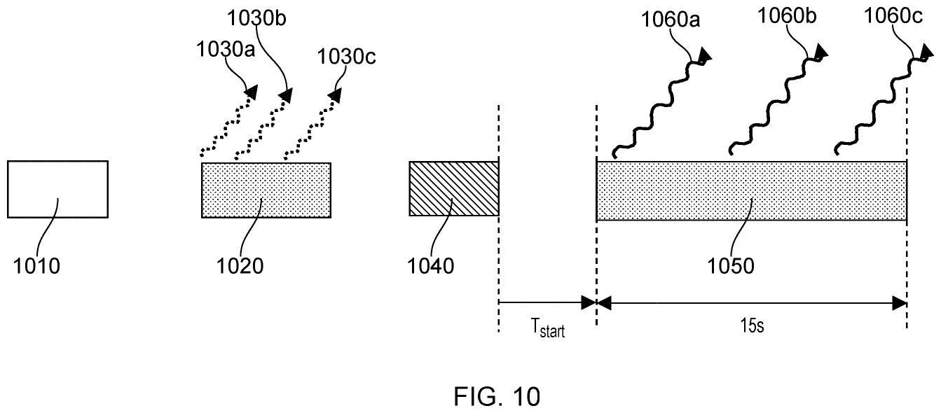

FIG. 10 shows as example of this arrangement. The reader sends a first command signal 1010 which requests that tags that receive the first command signal 1010 transmit an initial backscattering response (hereinafter referred to as an existence bit) indicating that they received the command signal 1010. The reader then transmits a first CW signal 1020 for use by the tags in transmitting a backscattered signal 1030 including an existence bit. In the example of FIG. 10, the reader received three backscattered signals 1030a-c and thus determines that three tags are in the proximity of the reader (i.e. three tags received the command signal 1010 and will receive future command signals and CW signals from the reader). Based on determining that there are three tags, the reader determines an appropriate length of an upcoming second CW signal 1050. The reader transmits a second command signal 1040 requesting tags to transmit their IDs. The second command signal 1040 may indicate timing parameters for the second CW signal 1050 in some examples. The reader then transmits the second CW signal 1050 with the determined length and receives three backscattered signals 1060a-c from the three tags, where each of the backscattered signals 1060 includes an ID of the respective tag.

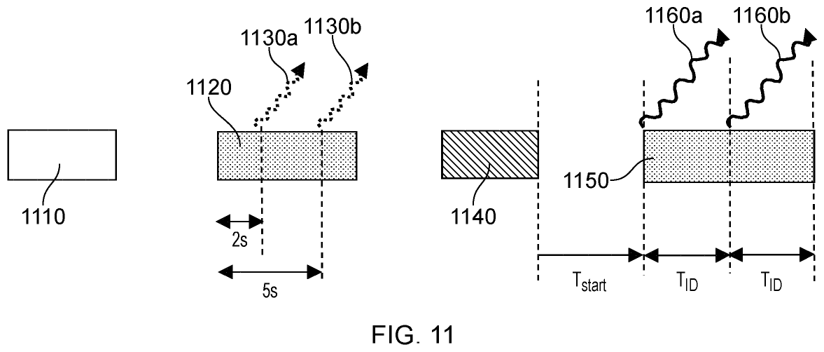

In some examples, the second command message may instruct specific tags to transmit their IDs during the second CW signal, where the tags are instructed based on the time at which they transmitted their backscattered signal. This example is shown in FIG. 11. In a similar manner to FIG. 10, a first command signal 1110 requests that tags transmit an existence bit. The reader then transmits a first CW signal 1120 and receives two backscattered signals 1130 from different tags during the CW signal transmission. A first backscattered signal 1130a is received by the reader two seconds after the start of the first CW signal 1120, while the second backscattered signal 1130b is received by the reader five seconds after the start of the first CW signal 1120.

The reader then transmits a second command signal 1140. The second command signal 1140 requests only that the tags that transmitted the backscattered signals 1130a-b provide their respective IDs. For example, the reader may have received other backscattered signals during the first CW signal 1120 in addition to backscattered signals 1130a and 1130b, however the reader may only request IDs from a subset of the tags from which existence bits 1130 were received. In order to do so, the second command signal 1140 may indicate the times at which the backscattered signals 1130a-b were received. The tag may then assess whether it transmitted its backscattered signal at one of the indicated times. If the tag determines that it did transmit its backscattered signal at one of the indicated times, the tag determines that its ID has been requested by the reader. Conversely, if the tag determines that it did not transmit its backscattered signal at one of the indicated times, the tag determines that its ID has not been requested by the reader.

The second command signal 1140, in addition to indicating which tags should send their IDs, may also indicate particular timeslots within the second CW signal 1160 in which the tags should send their respective identifiers. For example, a second command signal 1140 may request that the first tag (the tag that transmitted backscattered signal 1130a) transmits its backscattered signal 1160a (including its ID) within a first time window starting at T start-when the second CW signal 1150 starts (i.e. at time Tₛₜₐᵣₜ after the second command signal 1140 ends), and lasting for a duration of T_{ID}. Similarly, the second command signal 1140 may request that the second tag (the tag that transmitted backscattered signal 1130b) transmit its backscattered signal 1160b (including its ID) within a second time window starting at time Tₛₜₐᵣₜ+T_{ID} in the second CW signal 1150, and lasting for a duration of T_{ID}. Accordingly, as each tag is assigned its own transmission window, the possibility of a collision between backscattered signals is avoided.

As briefly discussed above, a reader may in some cases only request IDs from a subset of tags for which existence bits are transmitted. While this may be due to the reader intentionally requesting only a subset of the tag IDs, in other cases a reader may not successfully receive an existence bit transmitted by a particular tag. Accordingly, in a subsequent command signal, a tag which transmitted an existence bit may not be instructed to send its ID. In this scenario, the tag in question does not know whether it was deliberately not instructed to send its ID by the reader, or whether the reader did not receive the tag's existence bit. Accordingly, in a second CW signal in which other tags are instructed to send their IDs, the tag may re-transmit its existence bit. In some examples, if particular tags are assigned particular time windows of the CW signal in which to transmit their IDs, the reader may also provide an additional extension region of the CW signal for tags whose IDs were not requested to re-transmit their existence bits. Accordingly, the reader may be informed of any additional tags, to ensure that the reader has a complete view of the tags within range of the reader.

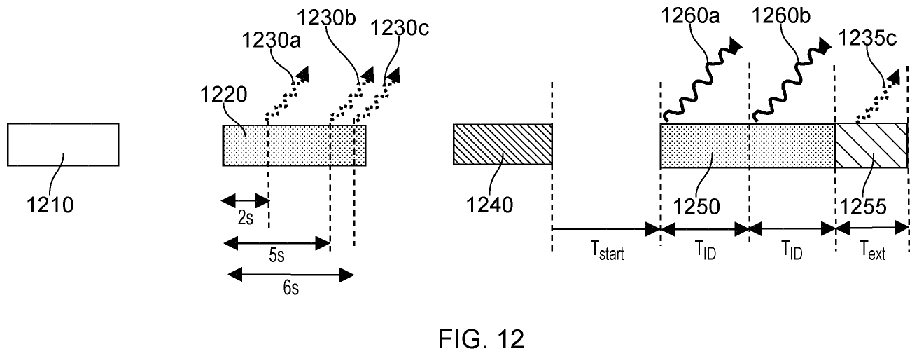

An example of this arrangement is shown in FIG. 12. The reader transmits a first command signal 1210 for receipt by a number of tags, where the first command signal requests existence bits from the tags. In a similar manner to FIG. 11, the reader then transmits a first CW signal 1220 and receives backscattered signals 1230a and 1230b from different tags, each including an existence bit, and transmitted 2 seconds and 5 seconds respectively after the first CW signal 1220 starts. In addition, a backscattered signal 1230c is transmitted by a third tag six seconds after the first CW signal 1220 starts, but it is not received by the reader. Accordingly, when the reader transmits the second command signal requesting IDs from specific tags based on the timings of their backscattered signals 1230, an ID is not requested from the third tag (that transmitted backscattered signal 1230c). Therefore, during the second CW signal 1250, backscattered signals 1260a and 1260b containing IDs are only received by the reader for the first and second tags respectively. In the present example, each of the tags is provided with a dedicated time window T_{ID}, in the same manner as described above in relation to FIG. 11.

However, in order to ensure that the reader is aware of all tags within its transmission range, the reader may also transmit the CW signal 1250 for an additional time 1255 (i.e. an extension time), Tₑₓₜ, which is not allocated to a tag for ID transmission. This extension time 1255 may be used to provide a dedicated time window for tags whose IDs were not requested to inform the reader of their existence using backscattered signals 1235c (e.g. containing an existence bit), such that the reader can confirm whether it is aware of all tags within range. This time window may, for example, be signalled in the second command signal 1240. The extension time 1255 may be comparatively short compared to the second CW signal 1250 or T_{ID}, as the tags only need to transmit a single bit informing the reader of its existence. As such, the reader can confirm whether it is aware of all the tags within its range with minimal additional signalling overheads.

As discussed above, the reader may modify the timing parameters of the CW signal according to the estimated number of tags. For example, the reader may calculate a probability of collision between backscattered signals from tags (containing tag IDs) based on the number of tags. This probability may be calculated in a number of ways, for example using Erlang formulas. If the determined probability of collision is above a predetermined threshold, the reader may adjust the timing parameters from a first set of default timing parameters to a second set of timing parameters. For example, the reader may repeat the process of requesting tag IDs by sending a further command signal requesting tag IDs and transmitting a further CW signal with a longer duration than the original CW signal. Accordingly, the tags are given a longer period of time in which to randomly transmit their IDs to the reader, thereby reducing the risk of collision.

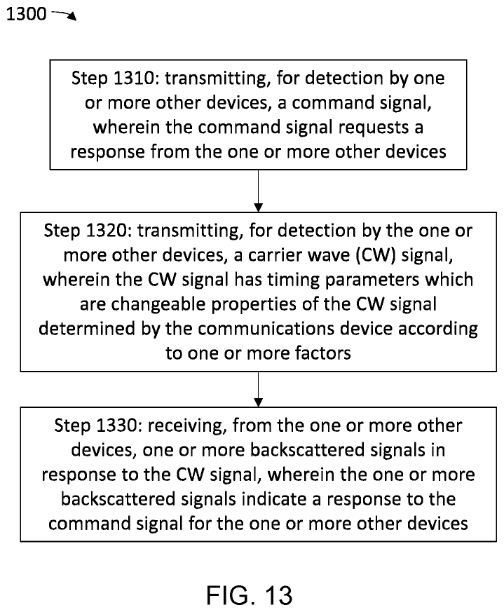

FIG. 13 illustrates an example method 1300 for a communications device (i.e. reader) configured to transmit and/or receive signals within a wireless communications network via a wireless radio interface provided by the wireless communications network. The method begins at step 1310, where the communications device transmits, for detection by one or more other devices, a command signal, wherein the command signal requests a response from the one or more other devices. The method continues to step 1320, where the communications device transmits 1320, for detection by the one or more other devices, a carrier wave (CW) signal, wherein the CW signal has timing parameters which are changeable properties of the CW signal determined by the communications device according to one or more factors. The method proceeds to step 1330, where the communications device receives, from the one or more other devices, one or more backscattered signals in response to the CW signal, wherein the one or more backscattered signals indicate a response to the command signal for the one or more other devices.

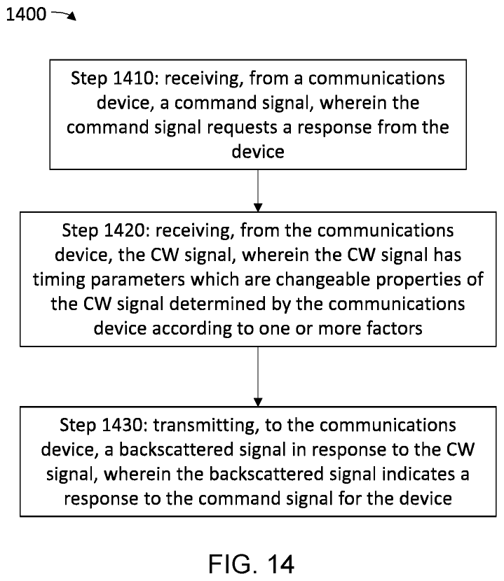

FIG. 14 illustrates an example method 1400 for a device configured to transmit a backscattered signal in response to a carrier wave (CW) signal from a communications device. The method includes step 1410 of receiving, from a communications device, a command signal, wherein the command signal requests a response from the device. The method proceeds to step 1420 of receiving, from the communications device, the CW signal, wherein the CW signal has timing parameters which are changeable properties of the CW signal determined by the communications device according to one or more factors. The method then continues to step 1430 of transmitting, to the communications device, a backscattered signal in response to the CW signal, wherein the backscattered signal indicates a response to the command signal for the device.

Further examples of feature combinations taught by the present disclosure are set out in the following numbered clauses:

1. A method for a communications device configured to transmit and/or receive signals within a wireless communications network via a wireless radio interface provided by the wireless communications network, the method comprising:
transmitting, for detection by one or more other devices, a command signal, wherein the command signal requests a response from the one or more other devices;
transmitting, for detection by the one or more other devices, a carrier wave (CW) signal, wherein the CW signal has timing parameters which are changeable properties of the CW signal determined by the communications device according to one or more factors;
receiving, from the one or more other devices, one or more backscattered signals in response to the CW signal, wherein the one or more backscattered signals indicate a response to the command signal for the one or more other devices.

2. The method according to clause 1, wherein the command signal requests an identifier of the one or more devices, and wherein the one or more backscattered signals indicates the respective identifiers for the one or more other devices.

3. The method according to any preceding clause, wherein the timing parameters include one or more of:
a start time for the CW signal,
   an end time for the CW signal,
a duration of the CW signal, and
   a delay of the CW signal.

4. The method according to any preceding clause, further comprising:
transmitting another CW signal, wherein the other CW signal has timing parameters that are different to the timing parameters of the CW signal.

5. The method according to any preceding clause, wherein the one or more factors used by the communications device for determining the timing parameters for the CW signal include one or more of:
a number of the one or more other devices, and
one or more other signals to be transmitted or received by the communications device.

6. The method according to any preceding clause, wherein the one or more backscattered signals are received concurrently with the transmission of the CW signal.

7. The method according to any preceding clause, wherein the timing properties of the CW signal are indicated by the command signal.

8. The method according to clause 7, wherein the timing properties of the CW signal indicated by the command signal include at least an end time of the CW signal.

9. The method according to clause 8, wherein the timing properties of the CW signal indicated by the command signal include at least the end time of the CW signal and a start time of the CW signal.

10. The method according to clause 8 or clause 9, wherein the end time of the CW signal is indicated in the command signal by the command signal indicating a duration of the CW signal.

11. The method according to clause 9 or clause 10, wherein the end time of the CW signal is indicated in the command signal by the command signal indicating a delay of the CW signal.

12. The method according to any preceding clause, wherein the CW signal includes a plurality of discrete portions.

13. The method according to clause 12, wherein the communications device transmits only one command signal for the plurality of portions of the CW signal.

14. The method according to clause 12 or clause 13, further comprising:
transmitting, for detection by the one or more other devices, another command signal, wherein the other command signal is transmitted after a first portion of the CW signal and before a second portion of the CW signal.

15. The method according to clause 14, wherein the other command signal indicates that transmission of the CW signal will be interrupted.

16. The method according to clause 14 or clause 15, wherein the other command signal indicates that the second portion of the CW signal is a continuation of the first portion of the CW signal, such that the first portion and the second portion are part of the same CW signal.

17. The method according to clause 14 or clause 15, wherein the other command signal indicates that the second portion of the CW signal is an extension to the first portion of the CW signal, such that the first portion and the second portion are part of the same CW signal.

18. The method according to any of clauses 12-17, wherein the one or more backscattered signals are received during the second portion of the CW signal.

19. The method according to any of clauses 12-18, wherein the one or more backscattered signals are received during the first portion of the CW signal.

20. The method according to any of clauses 12-19, wherein one or more first backscattered signals are received during the first portion of the CW signal and one or more second backscattered signals are received during the second portion of the CW signal, and wherein the one or more first backscattered signals are received from a set of devices different to a set of devices from which the one or more second backscattered signals are received.

21. The method according to any of clauses 12-20, wherein the command signal indicates timing parameters for each of the plurality of portions of the CW signal.

22. The method according to clause 21, wherein the timing parameters indicated by the command signal include a duration of the CW signal, wherein the duration of the CW signal is indicated as a length of time since a start of the CW signal.

23. The method according to clause 21, wherein the timing parameters indicated by the command signal include a duration of the CW signal, wherein the duration of the CW signal is indicated as a cumulative time for which the CW signal is transmitted across the plurality of discrete portions of the CW signal.

24. The method according to any of clauses 12-23, wherein the communication device transmits and/or receives one or more other signals, via the wireless radio interface provided by the wireless communications network, between respective portions of the CW signal.

25. The method according to any of clauses 12-24, wherein the plurality of portions of the CW signal are multiplexed with one or more other signals transmitted or received by the communications device via the wireless radio interface provided by the wireless communications network.

26. The method according to any of clauses 12-25, wherein the timing parameters for each of the plurality of portions of the CW signal are determined by the communications device prior to beginning transmission of the CW signal.

27. The method according to any preceding clause, further comprising:
estimating a number of the one or more other devices that will receive the command signal transmitted by the communications device; and
determining the timing parameters for the CW signal based on the estimated number of the one or more other devices.

28. The method according to clause 27, wherein estimating the number of the one or more other devices is based on a previous number of backscattered signals received by the communications device in response to a previous CW signal transmitted by the communications device.

29. The method according to clause 27 or clause 28, wherein estimating the number of the one or more other devices comprises:
transmitting, for detection by the one or more other devices, an initial command signal, the initial command signal requesting the one or more other devices to provide an indication of receipt of the initial command signal in an initial backscattered signal in response to the initial CW signal;
transmitting, for detection by the one or more other devices, the initial CW signal; and
receiving, from the one or more other devices, one or more initial backscattered signals, the one or more initial backscattered signals indicating that the respective other device received the initial command signal.

30. The method according to clause 29, wherein the one or more initial backscattered signals comprises a bit indicating that the respective other device received the initial command signal.

31. The method according to clause 29 or clause 30, further comprising:
determining a transmission time of the one or more initial backscattered signals; and
   determining, based on the received one or more initial backscattered signals, a subset of the one or more other devices for which an identifier is to be requested;
   wherein the command signal requests identifiers only for the subset of the one or more other devices, wherein the command signal requests identifiers only for the subset of the one or more other devices by indicating the determined transmission times of the one or more initial backscattered signals for the subset of the one or more other devices.

32. The method according to clause 31, wherein the command signal requests each of the determined subset of the one or more other devices to transmit a respective backscattered signal within a respective time period.

33. The method according to clause 31 or clause 32, further comprising:
receiving, in response to the CW signal, a backscattered signal from an additional device of the one or more other devices not included in the determined subset, the backscattered signal from the additional device indicating that the additional device received the initial command signal.

34. The method according to any of clauses 27-33, wherein determining the timing parameters for the CW signal based on the estimated number of the one or more other devices comprises:
based on the estimated number of the one or more other devices, determining a probability of a collision between backscattered signals of the one or more other devices.

35. The method according to clause 34, further comprising:
based on determining that the probability of a collision between backscattered signals of the one or more other devices is above a predetermined threshold, transmitting an additional command signal and an additional CW signal, wherein the additional CW signal has a longer duration than the CW signal.

36. The method according to any preceding clause, wherein the communications device is a terminal device configured to transmit signals to and/or to receive signals from an infrastructure equipment of the wireless communications network via the wireless radio interface.

37. The method according to any of clauses 1-35, wherein the communications device is an infrastructure equipment of the wireless communications network.

38. The method according to any preceding clause, wherein the one or more other devices include one or more radio frequency identification (RFID) tags.

39. A communications device comprising:
a transceiver configured to transmit and/or receive signals within a wireless communications network via a wireless radio interface provided by the wireless communications network; and
a controller configured with the transceiver to:
transmit, for detection by one or more other devices, a command signal, wherein the command signal requests a response from the one or more other devices;
transmit, for detection by the one or more other devices, a carrier wave (CW) signal, wherein the CW signal has timing parameters which are changeable properties of the CW signal determined by the communications device according to one or more factors;
receive, from the one or more other devices, one or more backscattered signals in response to the CW signal, wherein the one or more backscattered signals indicate a response to the command signal for the one or more other devices.

40. Circuitry for a communications device, the circuitry comprising:
transceiver circuitry configured to transmit and/or receive signals within a wireless communications network via a wireless radio interface provided by the wireless communications network; and
controller circuitry configured with the transceiver circuitry to:
   transmit, for detection by one or more other devices, a command signal, wherein the command signal requests a response from the one or more other devices;
transmit, for detection by the one or more other devices, a carrier wave (CW) signal, wherein the CW signal has timing parameters which are changeable properties of the CW signal determined by the communications device according to one or more factors;
receive, from the one or more other devices, one or more backscattered signals in response to the CW signal, wherein the one or more backscattered signals indicate a response to the command signal for the one or more other devices.

41. A method for a device configured to transmit a backscattered signal in response to a carrier wave (CW) signal from a communications device, the method comprising:
receiving, from a communications device, a command signal, wherein the command signal requests a response from the device;
receiving, from the communications device, the CW signal, wherein the CW signal has timing parameters which are changeable properties of the CW signal determined by the communications device according to one or more factors; and
transmitting, to the communications device, a backscattered signal in response to the CW signal, wherein the backscattered signal indicates a response to the command signal for the device.

42. The method according to clause 41, wherein the command signal requests an identifier of the device, and wherein the backscattered signal indicate the identifier for the device.

43. The method according to any of clauses 41-42, wherein the timing parameters include one or more of:
a start time for the CW signal,
an end time for the CW signal,
a duration of the CW signal, and
a delay of the CW signal.

44. The method according to any of clauses 41-43, further comprising:
receiving another CW signal, wherein the other CW signal has timing parameters that are different to the timing parameters of the CW signal.

45. The method according to any of clauses 41-44, wherein the one or more factors used by the communications device for determining the timing parameters for the CW signal include one or more of:
a number of devices that receive the CW signal, and
one or more other signals to be transmitted or received by the communications device.

46. The method according to any of clauses 41-45, wherein the backscattered signal is transmitted concurrently with the reception of the CW signal.

47. The method according to any of clauses 41-46, wherein the backscattered signal is transmitted by modulating the CW signal.

48. The method according to any of clauses 41-47, wherein the timing properties of the CW signal are indicated by the command signal.

49 The method according to clause 47, wherein the timing properties of the CW signal indicated by the command signal include at least an end time of the CW signal.

50. The method according to clause 49, wherein the timing properties of the CW signal indicated by the command signal include at least the end time of the CW signal and a start time of the CW signal.

51. The method according to clause 49 or clause 50, wherein the end time of the CW signal is indicated in the command signal by the command signal indicating a duration of the CW signal.

52. The method according to clause 50 or clause 51, wherein the end time of the CW signal is indicated in the command signal by the command signal indicating a delay of the CW signal.

53. The method according to any of clauses 41-52, wherein the CW signal includes a plurality of discrete portions.

54. The method according to clause 53, wherein the device receives only one command signal for the plurality of portions of the CW signal.

55. The method according to clause 53 or clause 54, further comprising:
receiving, from the communications device, another command signal, wherein the other command signal is received after a first portion of the CW signal and before a second portion of the CW signal.

56. The method according to clause 55, wherein the other command signal indicates that transmission of the CW signal will be interrupted.

57. The method according to clause 55 or clause 56, wherein the other command signal indicates that the second portion of the CW signal is a continuation of the first portion of the CW signal, such that the first portion and the second portion are part of the same CW signal.

58. The method according to clause 55 or clause 56, wherein the other command signal indicates that the second portion of the CW signal is an extension to the first portion of the CW signal, such that the first portion and the second portion are part of the same CW signal.

59. The method according to any of clauses 53-58, wherein the backscattered signal is transmitted during the second portion of the CW signal.

60. The method according to any of clauses 53-59, wherein the backscattered signal is transmitted during the first portion of the CW signal.

61. The method according to any of clauses 53-60, wherein the command signal indicates timing parameters for each of the plurality of portions of the CW signal.

62. The method according to clause 61, wherein the timing parameters indicated by the command signal include a duration of the CW signal, wherein the duration of the CW signal is indicated as a length of time since a start of the CW signal.

63. The method according to clause 61, wherein the timing parameters indicated by the command signal include a duration of the CW signal, wherein the duration of the CW signal is indicated as a cumulative time for which the CW signal is transmitted across the plurality of discrete portions of the CW signal.

64. The method according to any of clauses 53-63, wherein the plurality of portions of the CW signal are multiplexed with one or more other signals transmitted or received by the communications device via the wireless radio interface provided by the wireless communications network.

65. The method according to any of clauses 53-64, wherein the timing parameters for each of the plurality of portions of the CW signal are determined by the communications device prior to beginning transmission of the CW signal.

66. The method according to any of clauses 41-65, further comprising:
receiving, from the communications device, an initial command signal, the initial command signal requesting the device to provide an indication of receipt of the initial command signal in an initial backscattered signal in response to the initial CW signal;
receiving, from the communications device, the initial CW signal; and
transmitting, to the communications device, an initial backscattered signal, the initial backscattered signals indicating that the device received the initial command signal.

67. The method according to clause 66, wherein the initial backscattered signals comprises a bit indicating that the device received the initial command signal.

68. The method according to clause 66 or clause 67, wherein the command signal requests a response from the device by indicating a time at which the device transmitted the initial backscattered signal.

69. The method according to clause 68, wherein the command signal requests the device to transmit the backscattered signal within a particular time period.

70 The method according to any of clauses 41-69, wherein:
the command signal requests the device to provide an indication of receipt of the command signal,
the backscattered signal includes an indication that the device received the command signal, and wherein the device transmits the backscattered signal at a first transmission time;
wherein the method further comprises:
receiving a further command signal, wherein the further command signal indicates a set of transmission times, wherein the set of transmission times does not include the first transmission time; and
in response to determining that the set of transmission times indicated in the command signal does not include the first transmission time, transmitting a further backscattered signal, wherein the second backscattered signal indicates that the device received the further command signal.

71. The method according to any of clauses 41-70, wherein the communications device is a terminal device configured to transmit signals to and/or to receive signals from an infrastructure equipment of the wireless communications network via the wireless radio interface.

72. The method according to any of clauses 41-70, wherein the communications device is an infrastructure equipment of the wireless communications network.

73. The method according to any of clauses 41-72, wherein device is a radio frequency identification (RFID) tags.

74. A device comprising:
a transceiver configured to receive signals from a communications device and/or transmit backscattered signals to the communications device in response to a carrier wave (CW) signal, and
a controller configured with the transceiver to:
receive, from a communications device, a command signal, wherein the command signal requests a response from the device;
receive, from the communications device, the CW signal, wherein the CW signal has timing parameters which are changeable properties of the CW signal determined by the communications device according to one or more factors; and
transmit, to the communications device, a backscattered signal in response to the CW signal, wherein the backscattered signal indicates a response to the command signal for the device.

75. Circuitry for a device, the circuitry comprising:
transceiver circuitry configured to receive signals from a communications device and/or transmit backscattered signals to the communications device in response to a carrier wave (CW) signal, and
controller circuitry configured with the transceiver circuitry to:
receive, from a communications device, a command signal, wherein the command signal requests a response from the device;
receive, from the communications device, the CW signal, wherein the CW signal has timing parameters which are changeable properties of the CW signal determined by the communications device according to one or more factors; and
transmit, to the communications device, a backscattered signal in response to the CW signal, wherein the backscattered signal indicates a response to the command signal for the device.

76. A system comprising the communications device according to clause 39, and the device according to clause 74.

Therefore, from one perspective there has been described system, methods, communications devices and devices for utilisation of backscattered signal communication by devices operating in cellular networks. In particular, the duration of a carrier wave signal used for backscattering can be changed dynamically and/or the carrier wave signal can be interrupted and re-commenced/re-transmitted. As such, the transmission duration of the carrier wave signal can be tailored to the number of tags in the system. A command signal in the communication process may signal the timing of the carrier wave signal, the carrier wave signal may be terminated early, and/or the communications device (reader) may estimate the number of tags before determining the duration of the carrier wave signal.

### REFERENCES

[1] Holma H. and Toskala A, “LTE for UMTS OFDMA and SC-FDMA based radio access”, John Wiley and Sons, 2009.
[2] Dobkin, D. M., “The RF in RFID: Passive UHF RFID on Practice”, 2007, Chapter 3, Newns, ISBN: 978-0-7506-8209-1

1. A method for a communications device configured to transmit and/or receive signals within a wireless communications network via a wireless radio interface provided by the wireless communications network, the method comprising:
transmitting, for detection by one or more other devices, a command signal, wherein the command signal requests a response from the one or more other devices;
transmitting, for detection by the one or more other devices, a carrier wave (CW) signal, wherein the CW signal has timing parameters which are changeable properties of the CW signal determined by the communications device according to one or more factors;
receiving, from the one or more other devices, one or more backscattered signals in response to the CW signal, wherein the one or more backscattered signals indicate a response to the command signal for the one or more other devices.

2. The method according to claim 1, wherein the command signal requests an identifier of the one or more devices, and wherein the one or more backscattered signals indicates the respective identifiers for the one or more other devices.

3. The method according to claim 1, wherein the timing parameters include one or more of:
a start time for the CW signal,
an end time for the CW signal,
a duration of the CW signal, and
a delay of the CW signal.

4. The method according to claim 1, further comprising:
transmitting another CW signal, wherein the other CW signal has timing parameters that are different to the timing parameters of the CW signal.

5. The method according to claim 1, wherein the one or more factors used by the communications device for determining the timing parameters for the CW signal include one or more of:
a number of the one or more other devices, and
one or more other signals to be transmitted or received by the communications device.

6. The method according to claim 1, wherein the one or more backscattered signals are received concurrently with the transmission of the CW signal.

7. The method according claim 1, wherein the timing properties of the CW signal are indicated by the command signal.

8. The method according to claim 7, wherein the timing properties of the CW signal indicated by the command signal include at least an end time of the CW signal.

9. The method according to claim 8, wherein the timing properties of the CW signal indicated by the command signal include at least the end time of the CW signal and a start time of the CW signal.

10. The method according to claim 8, wherein the end time of the CW signal is indicated in the command signal by the command signal indicating a duration of the CW signal.

11. The method according to claim 9, wherein the end time of the CW signal is indicated in the command signal by the command signal indicating a delay of the CW signal.

12. The method according to claim 1, wherein the CW signal includes a plurality of discrete portions.

13. The method according to claim 12, wherein the communications device transmits only one command signal for the plurality of portions of the CW signal.

14. The method according to claim 12, further comprising:
transmitting, for detection by the one or more other devices, another command signal, wherein the other command signal is transmitted after a first portion of the CW signal and before a second portion of the CW signal.

15.-17. (canceled)

18. The method according to claim 12, wherein the one or more backscattered signals are received during the second portion of the CW signal.

19. The method according to claim 12, wherein the one or more backscattered signals are received during the first portion of the CW signal.

20. The method according to claim 12, wherein one or more first backscattered signals are received during the first portion of the CW signal and one or more second backscattered signals are received during the second portion of the CW signal, and wherein the one or more first backscattered signals are received from a set of devices different to a set of devices from which the one or more second backscattered signals are received.

21. The method according to claim 12, wherein the command signal indicates timing parameters for each of the plurality of portions of the CW signal.

22.-38. (canceled)

39. A communications device comprising:
a transceiver configured to transmit and/or receive signals within a wireless communications network via a wireless radio interface provided by the wireless communications network; and
a controller configured with the transceiver to:
transmit, for detection by one or more other devices, a command signal, wherein the command signal requests a response from the one or more other devices;
transmit, for detection by the one or more other devices, a carrier wave (CW) signal, wherein the CW signal has timing parameters which are changeable properties of the CW signal determined by the communications device according to one or more factors;
receive, from the one or more other devices, one or more backscattered signals in response to the CW signal, wherein the one or more backscattered signals indicate a response to the command signal for the one or more other devices.

40.-73. (canceled)

74. A device comprising:
a transceiver configured to receive signals from a communications device and/or transmit backscattered signals to the communications device in response to a carrier wave (CW) signal, and
a controller configured with the transceiver to:
receive, from a communications device, a command signal, wherein the command signal requests a response from the device;
receive, from the communications device, the CW signal, wherein the CW signal has timing parameters which are changeable properties of the CW signal determined by the communications device according to one or more factors; and
transmit, to the communications device, a backscattered signal in response to the CW signal, wherein the backscattered signal indicates a response to the command signal for the device.

75.-76. (canceled)
